(19) United States
(12) Patent Application Publication
(10) Pub. No.: US 2016/0100717 A1
(43) Pub. Date: Apr. 14, 2016

(54) Systems and Methods for Automated Food Preparation

(71) Applicant: Yuanji Zhu, Atlanta, GA (US)

(72) Inventor: Yuanji Zhu, Atlanta, GA (US)

(21) Appl. No.: 14/683,454

(22) Filed: Apr. 10, 2015

Related U.S. Application Data
(60) Provisional application No. 62/062,875, filed on Oct. 11, 2014.
(60) Provisional application No. 62/089,833, filed on Dec. 10, 2014.

(51) Int. Cl. A47J 44/00; A47J 36/00

(52) U.S. Cl. CPC A47J 44/00; A47J 36/00

(57) ABSTRACT

Described herein are systems and methods for automatedly and/or remotely preparing food items for consumption. In one aspect, a food preparation system may comprise a refrigeration unit, a cooking unit, a control unit, and a transportation unit configured to transport food items from the refrigeration unit to the cooking unit. In another aspect, various aspects of the refrigeration unit, the cooking unit, and/or the transportation of food items from the refrigeration unit and cooking unit may be initiated or scheduled by a user remotely via a network configured to transmit to, and receive information from, the control unit. The transportation unit may also comprise one or more reservoirs for the delivery of substantially liquid ingredients. Such reservoir contents may be delivered to the cooking unit in concert with or independent of any contents of the refrigeration unit.

This non-provisional application claims the benefit of priority to U.S. Provisional Patent Application No. 62/062,875, filed Oct. 11, 2014, and U.S. Provisional Patent Application No. 62/089,833, filed Dec. 10, 2014, both of which are expressly incorporated herein by reference.

### FIELD OF THE DISCLOSURE

The embodiments relate generally to systems and methods for automated or remote cooking and, more specifically, systems and methods for automatedly delivering fresh and sanitary ingredients to a cooking system.

### BACKGROUND

In this fast-paced world, people dedicate more and more time on work and travel. Cooking can be a time intensive task for which many lack the time. Arriving home late from a stressful day, hungry and tired, one's remaining energy must be spent gathering ingredients and preparing meals, leaving relatively little time left before bed to engage in more desirable activities.

New remote-controlled or Internet-capable outlets and appliances address some of these concerns. But even these systems and devices require the user to gather and prepare ingredients prior to placing them into a cooking device, such as an oven, toaster, crockpot, etc. Unless one is slow-cooking the ingredients all day, ingredients that otherwise would be stored in a refrigerator or freezer must sit in the cooking device (for example, at room temperature) until an appropriate time to initiate the cooking process. This leaves open the possibility of spoilage or the ingredients otherwise becoming unsuitable or undesirable for consumption before the cooking process is initiated. Moreover, some recipes or food preparation calls for the pre-heating of the cooking device. Such pre-heating is not possible where the food or ingredients have already been placed in the cooking device.

Thus, a need exists for improved systems and techniques for the remote-controlled or automated preparation of meals using fresh ingredients. Moreover, improved systems and techniques are needed to ensure the quality, accuracy, and reliability of remote- or automated-cooking.

### SUMMARY OF THE DISCLOSURE

In accordance with certain embodiments of the present disclosure, a remotely controlled or automated food preparation system is disclosed. In one aspect, the remotely controlled food preparation system may comprise a control unit, a refrigeration unit, a transportation unit, and a cooking unit. In one embodiment, the control unit may serve to transmit and receive information to and from one or more users. Such information may be transmitted or received over a network such as the Internet or a private network. The control unit may be further configured to control one or more aspects of the refrigeration unit, the transportation unit, and/or the cooking unit.

In one aspect, a user may load one or more food items into a refrigeration unit. The user may also configure one or more aspects of the refrigeration unit (e.g., state and/or temperature information) directly or remotely.

In accordance with input from a user and/or a predetermined schedule set or selected by the user, the one or more food items may be transported to the cooking unit by the transportation unit. The transportation unit may comprise one or more devices or components for conveying the food items from the refrigeration unit to the cooking unit. The transportation unit may further comprise one or more reservoirs for storing liquid or substantially liquid food ingredients for delivery to the cooking unit. Such reservoir contents may be delivered to the cooking unit simultaneously or in concert with the food items placed in the refrigeration unit, or such reservoir contents may be delivered to the cooking unit independent of delivery of the food items placed in the refrigeration unit.

In another aspect, the cooking unit may heat or cook items transported thereto in accordance with input from the user and/or a predetermined schedule set or selected by the user. For example, the user may configure one or more aspects of the cooking unit (e.g., state and/or temperature information) directly or remotely.

Additional objects and advantages of the present disclosure will be set forth in part in the description which follows, and in part will be obvious from the description, or may be learned by practice of the disclosure. The objects and advantages of the disclosure will be realized and attained by means of the elements and combinations particularly pointed out in the appended claims.

It is to be understood that both the foregoing general description and the following detailed description are illustrative and explanatory only and are not restrictive of the claims.

The accompanying drawings, which are incorporated in and constitute a part of this specification, illustrate several embodiments and together with the description, serve to explain the principles of the disclosure.

### BRIEF DESCRIPTION OF THE DRAWINGS

FIG. 1 depicts some aspects of an illustrative embodiment of a system as described herein.

FIG. 2 depicts some aspects of an illustrative embodiment of a system as described herein.

FIG. 3 depicts some aspects of an illustrative embodiment of a computing system as described herein.

FIG. 4 depicts some aspects of an illustrative embodiment of a method as described herein.

FIG. 5 depicts some aspects of an illustrative embodiment of a system as described herein.

FIG. 6 depicts some aspects of an illustrative embodiment of a system as described herein.

### DESCRIPTION OF THE EMBODIMENTS

Disclosed herein are various embodiments of systems and methods for an automated and/or remotely-controlled food preparation system. While the systems and methods described herein are primarily concerned with food preparation systems for use in a personal cooking setting, one skilled in the art will appreciate that the systems and methods described below can be used in other contexts, including residential, industrial, and commercial cooking systems, or any other setting in which it may be desirable to automate or remotely-control a food preparation system.

Reference will now be made in detail to certain illustrative embodiments, examples of which are illustrated in the accompanying drawings. Wherever possible, the same reference numbers will be used throughout the drawings to refer to the same or like items.

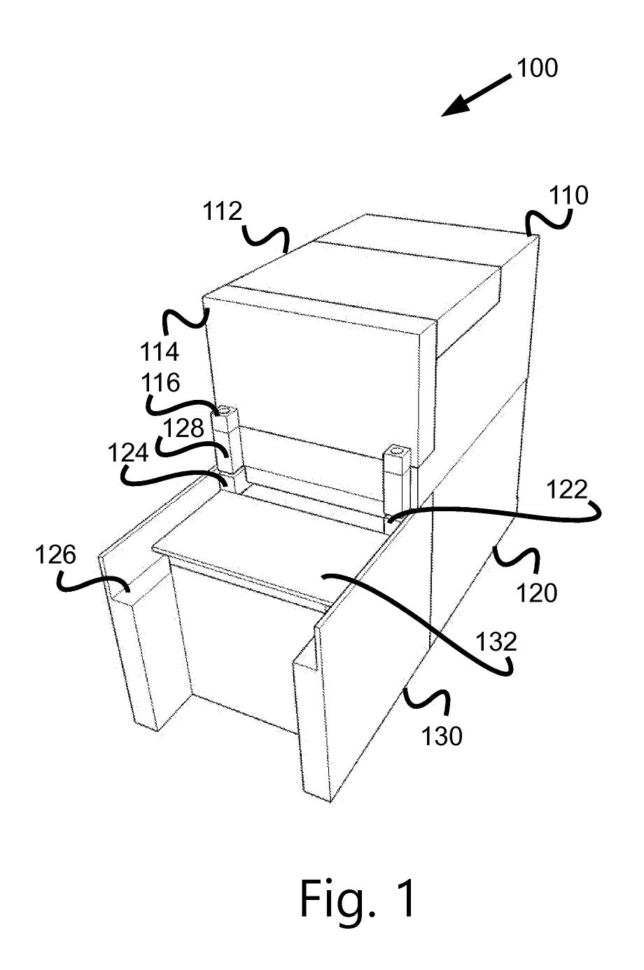

FIG. 1 depicts one illustrative embodiment of an automated food preparation system 100. In one aspect, the food preparation system may comprise a communication unit (not shown in FIG. 1), a refrigeration unit 110, a transportation unit 120, and a cooking unit 130. In one embodiment, refrigeration unit 110 may be positioned substantially above transportation unit 120. In a further embodiment, transportation unit may be positioned side-by-side or adjacent with cooking unit 130, such that cooking unit 130 and refrigeration unit 110 may not share a common wall and/or interface. In other embodiments, cooking unit 130 and refrigeration unit 110 may positioned in any suitable manner so as to reduce or limit heat exchange between the two units. Of course, alternative embodiments are also possible and any suitable arrangement or positioning of refrigeration unit 110, transportation unit 120, and cooking unit 130 may be implemented.

In another aspect, refrigeration unit 110 may comprise an interior cavity, one or more loading doors 112, one or more transfer doors 114, and a heat pump (mechanical, electrical, or chemical). In use, the heat pump may be configured to transfer heat from the interior cavity of refrigeration unit 110 to the external environment such that the interior cavity reaches a temperature below room temperature. In other embodiments, refrigeration unit 110 may comprise any other suitable technology employed in known refrigeration units.

In another aspect, one or more loading doors 112 may allow access to the interior cavity by the user. For example, a user may open doors 112 to place food or ingredients inside the interior cavity of refrigeration unit 110 or to remove food or ingredients from inside the interior cavity. As described in greater detail below, one or more transfer doors 114 of refrigeration unit 110 may cooperate with transportation unit 120 in the transfer of any contents (i.e., food/ingredients) placed in the interior cavity of refrigeration unit 110 to cooking unit 130.

In a further aspect, refrigeration unit 110 may be configured to maintain the contents of its interior cavity at a predetermined temperature within a temperature range. In one embodiment, the temperature range may be 28° F. (−2° C.) to 45° F. (7° C.). In other embodiments, refrigeration unit 110 may be configured to maintain contents in a frozen state. In such embodiments, the temperature range may be −29° F. (−34° C.) to 45° F. (7° C.). In still further embodiments, rather than a refrigeration unit, unit 110 may serve as a warmer or pre-heater. Alternatively, unit 110 may maintain its contents at substantially room temperature while preventing outside contaminants to contact the contents.

In one aspect, the temperature of the refrigeration unit may be set manually, using an input (e.g., buttons, touchpad, dial, etc.) located at or near system 100, or remotely (e.g., transmitting commands over a network). The temperature at which refrigeration unit 110 may be set may vary depending upon the contents of refrigeration unit 110, how long the contents will be stored in refrigeration unit 110, and/or the desired temperature of the contents to be placed into cooking unit 130. In further embodiments, the temperature of refrigeration unit 110 may be set to vary over time, e.g., begin at a temperature below room temperature and slowly approach room temperature as the time nears to transport the contents of refrigeration unit 110 to cooking unit 130. Moreover, refrigeration unit may be programmed to turn on or off, or vary the temperature within the cavity in accordance with a predetermined time or schedule, and/or based, at least in part, on the occurrence of one or more events.

In another aspect, system 100 may comprise a transportation unit 120. In one embodiment, transportation unit 120 may be positioned substantially below or underneath refrigeration unit 110. In other embodiments, transportation unit 120 may be positioned elsewhere in relation to refrigeration unit 110.

In one embodiment, transportation unit 120 may comprise one or more processor- or controller-based control units, one or more linear actuators, one or more water pumps, and/or one or more reservoirs. The transportation unit may further comprise a dynamic extrusion component 122. In the embodiment depicted in FIG. 1, dynamic extrusion component 122 may be located substantially below or underneath a portion of refrigeration unit 110, such as, for example, below or underneath one or more doors 114 of refrigeration unit 110. In other embodiments, dynamic extrusion component 122 may be located at any suitable location with respect to refrigeration unit 110 and/or the remainder of transportation unit 120.

In one aspect, dynamic extrusion component 122 may comprise a pair of opposing guide members 124 configured to move along a pair of respective rails 126. In one embodiment, dynamic extrusion component 122 may be configured to slide, via guide members 124, along opposing rails 126 based, at least in part, on forces exerted on dynamic extrusion component 122 by one or more linear actuators (not depicted). IN further embodiments, guide members 124 may comprise wheels to reduce friction between dynamic extrusion component 122 and opposing rails 126 as dynamic extrusion component 122 slides or rolls along rails 126. In other embodiments, dynamic extrusion component 122 may be configured to move or slide along opposing rails 126 in some other suitable manner, e.g., a screw-action actuator, gear-and-chain, pneumatic or hydraulic piston, etc.

In another aspect, dynamic extrusion component 122 may comprise one or more locking mechanisms 128. In one embodiment, such locking mechanisms 128 may be configured to cooperate with one or more lock receptacles 116 of transfer door(s) 114 of refrigeration unit 110. In one embodiment, locking mechanism(s) 128 of dynamic extrusion component 122 may comprise a linear actuator, bolt, or piston configured to engage and/or disengage lock receptacles 116 of refrigeration unit 110. In such an embodiment, lock receptacles 116 may comprise a recess, opening, aperture, or hole for receiving the actuator, bolt, or piston of locking mechanism 128. In this manner, and in one embodiment, when locking mechanism 128 of dynamic extrusion component 122 engage lock receptacles 116 of transfer door(s) 114 of refrigeration unit 110, transfer door(s) 114 of refrigeration unit 110 may move with dynamic extrusion component 122 along opposing rails 126. On the other hand, in such an embodiment, when locking mechanism 126 of dynamic extrusion component 122 disengages lock receptacles 116 of transfer door(s) 114 of refrigeration unit 110, dynamic extrusion component 122 may move along opposing rails 126 independent of transfer door(s) 114 of refrigeration unit 110 (or while transfer door(s) 114 remain stationary).

In a further aspect, transportation unit 120 may comprise an access door (not shown) for allowing a user access to one or more components, control units, linear actuators, water pumps, and/or reservoirs.

System 100 may further comprise a cooking unit 130. In one embodiment, cooking unit 130 may be located adjacent or side-by-side with respect to transportation unit 120. In such embodiments, refrigeration unit 110 and cooking unit 130 may not share a common wall or interface, or otherwise be positioned such that heat exchange between the two units may easily occur. In other embodiments, cooking unit 130 may be located at any suitable location with respect to transportation unit 120 and/or refrigeration unit 110.

Cooking unit 130 may comprise an interior cavity, a lid 132, and one or more heating components (not shown) configured to heat the interior cavity of cooking unit 130 to a desired temperature. In one embodiment, cooking unit 130 may comprise an oven, a toaster, steamer, a crockpot, a smoker, a grill, or any other conventional cooking device used in the preparation of food items.

In one aspect, cooking unit 130 may be configured to maintain the contents of its interior cavity at a predetermined temperature within a temperature range. In one embodiment, the temperature range may be 100° F. (38° C.) to 800° F. (427° C.). In other embodiments, cooking unit 130 may be configured to warm, defrost, or thaw its contents below, at, or above room temperature while preventing outside contaminants to contact the contents.

In one aspect, the temperature of cooking unit 130 may be set manually, using an input (e.g., buttons, touchpad, dial, etc.) located at or near system 100, or remotely (e.g., transmitting commands over a network). The temperature at which cooking unit 130 may be set may vary depending upon the contents of cooking unit 130, how long the contents will be stored in cooking unit 130, and/or the desired temperature to be reached for the internal temperature of the contents. In further embodiments, the temperature of cooking unit 130 may be set to vary over time, e.g., begin at a first temperature and rise or fall to a second temperature at a predetermined rate. Moreover, cooking unit 130 may be programmed to turn on or off, or vary the temperature within the cavity in accordance with a predetermined time or schedule, and/or based, at least in part, on the occurrence of one or more events.

In another aspect, lid 132 may be positioned such that at least a portion of lid 312 may reside in a path that dynamic extrusion component 122 traverses along opposing rails 126. In one embodiment, when lid 132 is in a closed position (i.e., lid 132 may be positioned substantially over the interior cavity of cooking unit 130, such that the interior cavity is not substantially open to the external environment), a rear-facing surface of lid 132 may abut or nearly abut dynamic extrusion component 122 and/or guide members 124. In such embodiments, as dynamic extrusion component 122 and/or guide members 124 move along opposing rails 126, at least a portion of dynamic extrusion component 122 and/or guide members 124 may exert force on at least a portion of lid 132, and lid 132 may also move along opposing rails 126. In further embodiments, lid 132 may comprise one or more wheels (not shown) located at or near rails 126 to reduce friction between lid 132 and opposing rails 126 as lid 132 slides or rolls along rails 126.

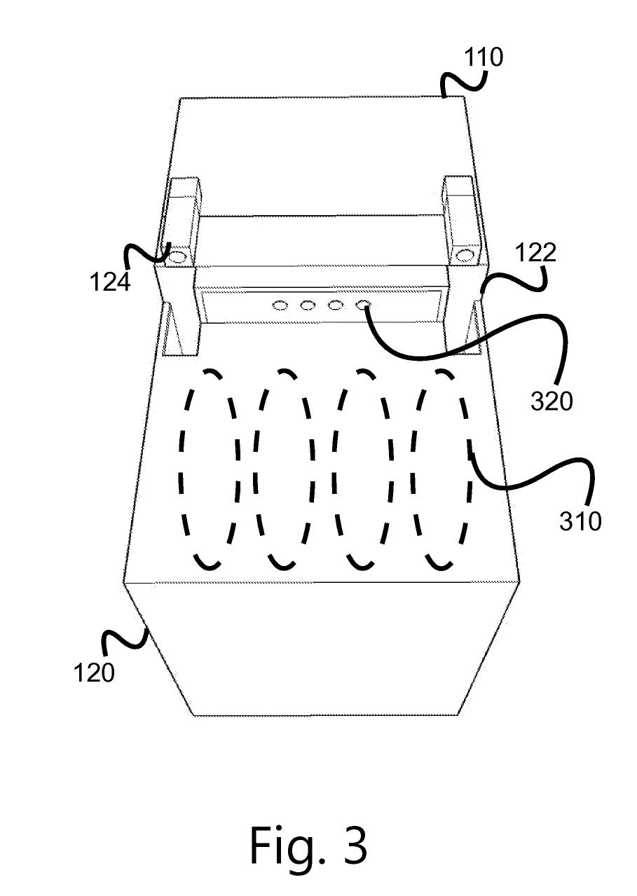

In this manner, the force used to move dynamic extrusion component 122 along opposing rails 126 may result in a substantially simultaneous and synchronized movement of transfer door(s) 114 of refrigeration unit 110 and lid 132 of cooking unit 130. As described above, movement of dynamic extrusion component 122 may be accomplished by one or more linear actuators, screws, gears-and-pulleys, or other mechanical action initiated by the control unit (an embodiment of which is depicted in FIG. 3). In one embodiment, dynamic extrusion component 122 may be configured to travel along opposing rails 126 such a distance as to allow transfer door(s) 114 to move above or substantially above the interior cavity of cooking unit 130. In other embodiments, dynamic extrusion component 122 may be configured to travel along opposing rails 126 such a distance as to allow transfer door(s) 114 to move beyond the interior cavity of cooking unit 130. In still other embodiments, dynamic extrusion component 122 may be configured to travel along opposing rails 126 such a distance as to sufficiently remove lid 132 from cooking unit 130 and/or allow access to the interior cavity of cooking unit 130. Further details regarding the movement of dynamic extrusion component 122, lid 132 of cooking unit 130, transfer door(s) 114 of refrigeration unit 110, and/or the contents of refrigeration unit 110 to cooking unit 130 via transportation unit 120 are discussed below.

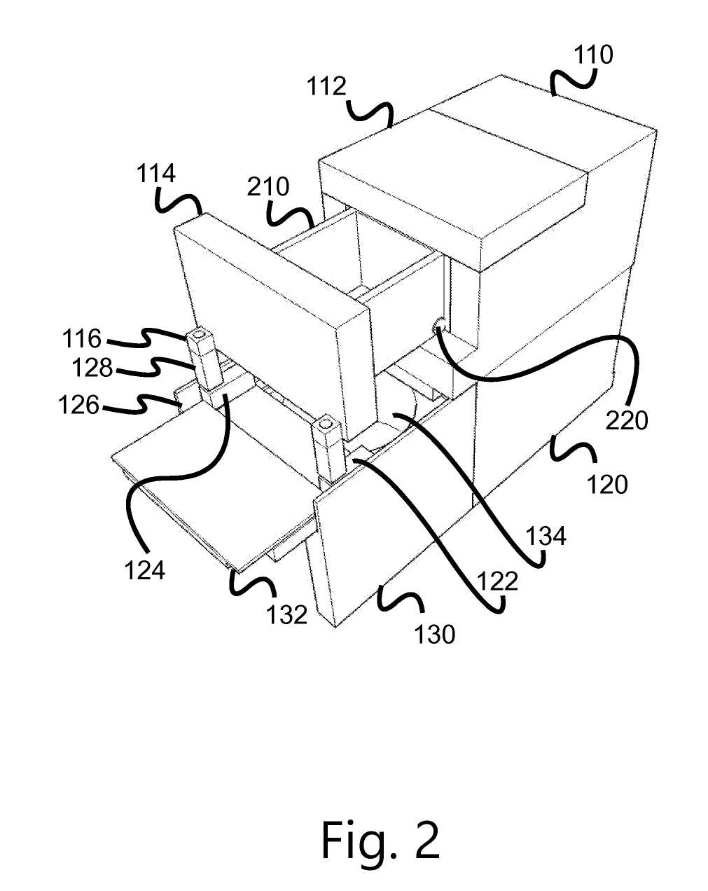

FIG. 2 depicts another embodiment of food preparation system 100. In one aspect, dynamic extrusion component 122 may be in a partially or fully extended state. In one embodiment dynamic extrusion component 122 may comprise one or more guide members 124 and one or more locking mechanisms 128. In such embodiments, guide members 124 may be configured to slide or otherwise move along opposing rails 126. Such movement may be mechanically and/or electrically driven in any suitable manner, including but not limited to, the use of linear actuators, screw-action, gear(s), pneumatic or hydraulic piston, etc.

In embodiments in which locking mechanisms 128 may be engaged with lock receptacles 116 of refrigeration unit 110, transfer door(s) 114 of refrigeration unit 110 may move in conjunction with dynamic extrusion component 122. In a further aspect, transfer door(s) 114 may be coupled to an interior liner 210 of refrigeration unit. In one embodiment, liner 210 may define an interior cavity of refrigeration unit 110. In further embodiments, liner 210 may have an aperature or opening in its lower surface and/or have no lower surface at all. In such embodiments, as transfer door(s) 114 move along with dynamic extrusion component 122 and liner 210 emerges from refrigeration unit 110, any contents of the interior cavity of refrigeration unit 110 (e.g., food items placed into refrigeration unit 110 via loading door(s) 112, may fall, via gravity, out the bottom of liner 210. As discussed above, in some embodiments, the movement of transfer door(s) 114 and/or liner 210 may be further facilitated by one or more wheels or friction reducing devices 220.

In another aspect, one or more portions of dynamic extrusion component 122 may abut or otherwise be in contact with lid 132 of cooking unit 130 such that, as dynamic extrusion component extends or moves along rails 126, lid 132 also slides along rails 126 and exposes an interior cavity 134 of cooking unit 130. In such embodiments, interior cavity 134 may be located such that any contents of refrigeration unit 110 displaced by liner 210 are received at interior cavity 134. In one embodiment, for example, as transfer door(s) 114 and liner 210 move along with dynamic extrusion component 122 and food items placed in refrigeration unit 110 fall from liner 210, those food items may be received or otherwise contained by interior cavity 134 of cooking unit 130.

FIG. 3 depicts another view of system 100 and, in particular, another aspect of transportation unit 120 and dynamic extrusion component 122. In one aspect, transportation unit 120 may comprise one or more reservoirs 310 configured to contain or receive fluid food items such as sauces and/or liquid ingredients. Reservoirs 310 may be accessible to (and/or fillable by) a user through an access door in transportation unit 120. The contents of reservoirs 310 may be in fluid communication with dynamic extrusion component 122 via one or more tubes, pipes, or conduits (not shown). In one embodiment, dynamic extrusion component 122 may comprise one or more ports 320 in fluid communication with reservoirs 310 for dispensing any contents of reservoirs 310. In further embodiments, when dynamic extrusion component 122 may be located substantially above at least a portion of cavity 134 of cooking unit 130 (as shown in FIG. 2), one or more items from reservoirs 310 may be dispensed via ports 320 into interior cavity 134 of cooking unit 130.

In another aspect, the displacement of ingredients from reservoirs 310 through one or more conduits to ports 320 may be accomplished in any suitable manner. In one embodiment, an electrical, mechanical, and/or electro-mechanical pump may be used. In other embodiments, reservoirs 310 and/or the conduits may be in communication with a pressurized system (e.g., CO₂ tank(s)) that may be used to propel or otherwise move ingredients from reservoirs 310 to ports 320 and, ultimately, into interior cavity 134 of cooking unit 130.

Following delivery of food items from refrigeration unit 110 and/or reservoirs 310 to cooking unit 130 via, for example, dynamic extrusion component 122 and/or liner 210, dynamic extrusion component 122 may retract and/or return to its placement depicted in FIG. 1. In embodiments in which locking mechanism 128 may be engaged with lock receptacles 116 of refrigeration unit 110, transfer door(s) 114 may also retract or move to return liner 210 to refrigeration unit 110 and/or close refrigeration unit 110. In other embodiments in which dynamic extrusion component 122 may be coupled to lid 132 of cooking unit 130, as dynamic extrusion component 122 may retract and/or return to its placement depicted in FIG. 1, lid 132 may slide or otherwise move over interior cavity 134, closing cooking unit 130.

Any food items located in interior cavity 134 of then closed cooking unit 130 may be heated and or cooked according to a user's preferences.

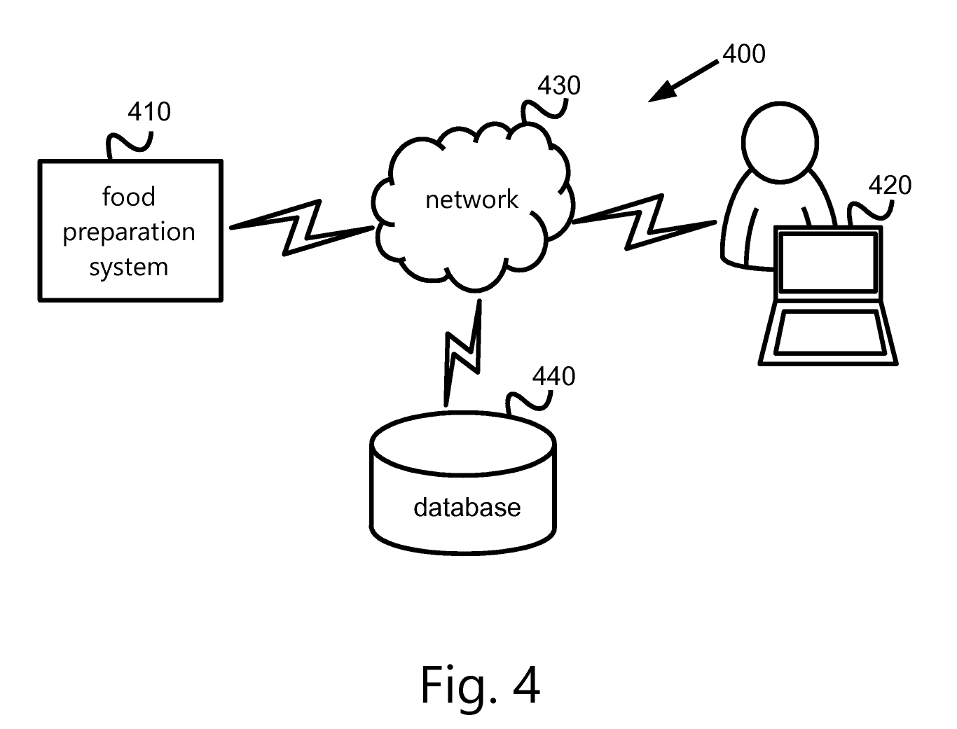

FIG. 4 depicts a communication system 400. In one aspect, communication system 400 may comprise a food preparation system 410 (substantially similar to the system depicted in FIG. 1), a user's communication device 420, and a communication network 430. In one embodiment, communication system 400 may further comprise a database 440.

In another aspect, communication device 420 may comprise any device that a user may use to transmit information to or receive information from food preparation system 410, network 430, and/or database 440. In a further aspect, communication device 420 may comprise one or more buttons, touchscreens, scroll wheels, switches, and other components configured to receive input from a user. In one embodiment, communication device 420 may be a tablet, smart phone, smart watch, laptop, desktop computer, or another processor- or controller-based device configured to accept input(s) from a user, and/or receive and transmit information over a network.

In a further aspect, communication device 420 may be configured to communicate with food preparation system 410 via network 430. In one embodiment, network 430 may be any one- or two-way communication channel, and communication device 420 may be wire- or wirelessly-connected to food preparation system 410. In further embodiments, network 430 may comprise the Internet, an open network, a private/home network, IR, RF, or Bluetooth communication channels, or some combination thereof. In this manner, communication device 420 may be configured to remotely transmit commands to, or receive information from, food preparation system 410. For example, a user may input commands to communication device 420 for turning on or off one or more components of food preparation system 410, setting a temperature or temperature program (temperature variation schedule) of one or more components of food preparation system 410, and/or initiating or scheduling the movement of one or more components of food preparation system 410. In further embodiments, communication device 420 may be used to transmit any commands to food preparation system 410 that the control system of food preparation system 410 may be configured to execute.

In one embodiment, communication system 400 may comprise a database 240. In such embodiments, food preparation system 410 and/or communication device 420 may be configured to transmit information to or recall information from database 440. In further embodiments, database 440 may be configured to store user-specific or profile information, information pertaining to food preparation system 410 settings, recipes or cooking schedules/programs, and/or any other suitable information.

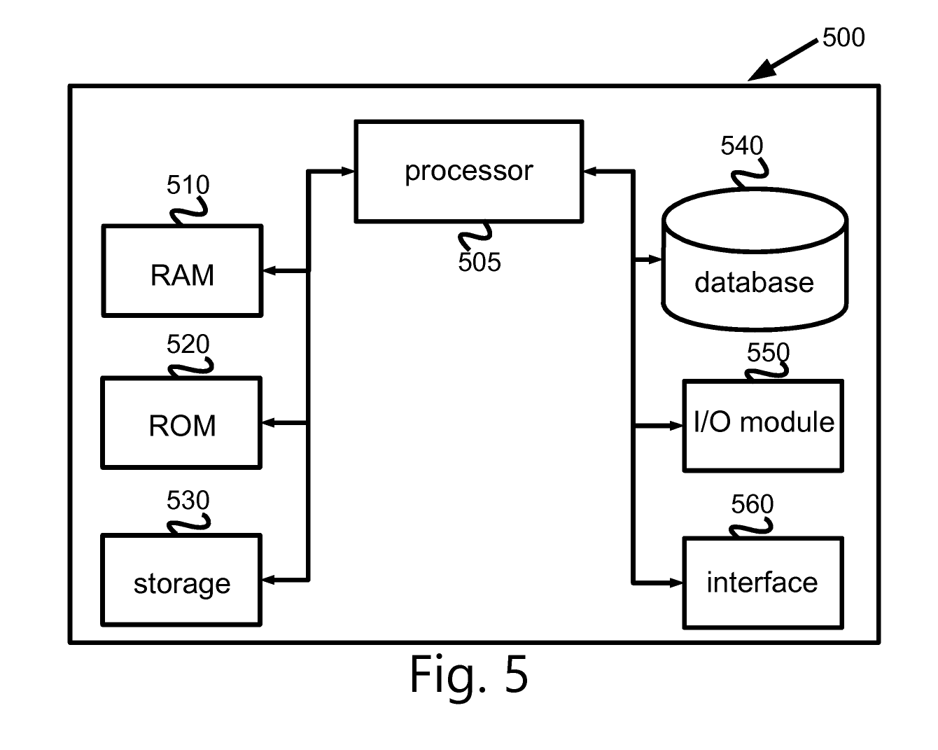

FIG. 5 depicts a processor-based computing system 500 representative of a computing system that may be found in (or cooperate with) any one or more of food preparation system 510, communication device 520, network 530, and/or database 540.

In particular, system 500 may comprise one or more hardware and/or software components configured to execute software programs, such as software or circuitry for storing, processing, and analyzing data. For example, system 500 may include one or more hardware components such as, for example, processor 505, a random access memory (RAM) module 510, a read-only memory (ROM) module 520, a storage system 530, a database 540, one or more input/output (I/O) modules 550, and an interface module 560. Alternatively and/or additionally, system 500 may include one or more software components such as, for example, a computer-readable medium including computer-executable instructions for performing methods consistent with certain disclosed embodiments. It is contemplated that one or more of the hardware components listed above may be implemented using software. For example, storage 530 may include a software partition associated with one or more other hardware components of system 500. System 500 may include additional, fewer, and/or different components than those listed above. It is understood that the components listed above are illustrative only and not intended to be limiting.

Processor 505 may include one or more processors, each configured to execute instructions and process data to perform one or more functions associated with system 500. As illustrated in FIG. 5, processor 505 may be communicatively coupled to RAM 510, ROM 520, storage 530, database 540, I/O module 550, and interface module 560. Processor 505 may be configured to execute sequences of computer program instructions to perform various processes, which will be described in detail below. The computer program instructions may be loaded into RAM for execution by processor 505.

RAM 510 and ROM 520 may each include one or more devices for storing information associated with an operation of system 500 and/or processor 505. For example, ROM 520 may include a memory device configured to access and store information associated with system 500, including information for identifying, initializing, and monitoring the operation of one or more components and subsystems of system 500. RAM 510 may include a memory device for storing data associated with one or more operations of processor 505. For example, ROM 520 may load instructions into RAM 510 for execution by processor 505.

Storage 530 may include any type of storage device configured to store information that processor 505 may need to perform processes consistent with the disclosed embodiments.

Database 540 may include one or more software and/or hardware components that cooperate to store, organize, sort, filter, and/or arrange data used by system 500 and/or processor 505. For example, database 540 may include user-specific account information, predetermined menu/display options, and other user preferences. Alternatively, database 540 may store additional and/or different information.

I/O module 550 may include one or more components configured to transmit information between the various components of communication system 400. For example, I/O module 550 may facilitate transmission of data between food preparation system 410, communication device 420, network 430, and/or database 440. I/O module 550 may further allow a user to input parameters associated with communication system 400 or any one or more of its components via a touchpad, keypad, touchscreen, or another input component of one or more of food preparation system 410 and communication device 420. I/O module 550 may also facilitate transmission of visual indicators (e.g., LED indicators) or display data including a graphical user interface (GUI) for outputting information onto a viewing surface or graphical display. I/O module 550 may also include peripheral devices such as, for example, ports to allow a user to input data stored on a portable media device, a microphone, or any other suitable type of interface device. I/O module 550 may also include ports to allow a user to output data stored within any component of communication system 400 to, for example, an external component.

Interface 560 may include one or more components configured to transmit and receive data via a communication network, such as the Internet, a local area network, a workstation peer-to-peer network, a direct link network, a wireless network, or any other suitable communication platform. For example, interface 560 may include one or more modulators, demodulators, multiplexers, demultiplexers, network communication devices, wireless devices, antennas, modems, and any other type of device configured to enable data communication via a communication network.

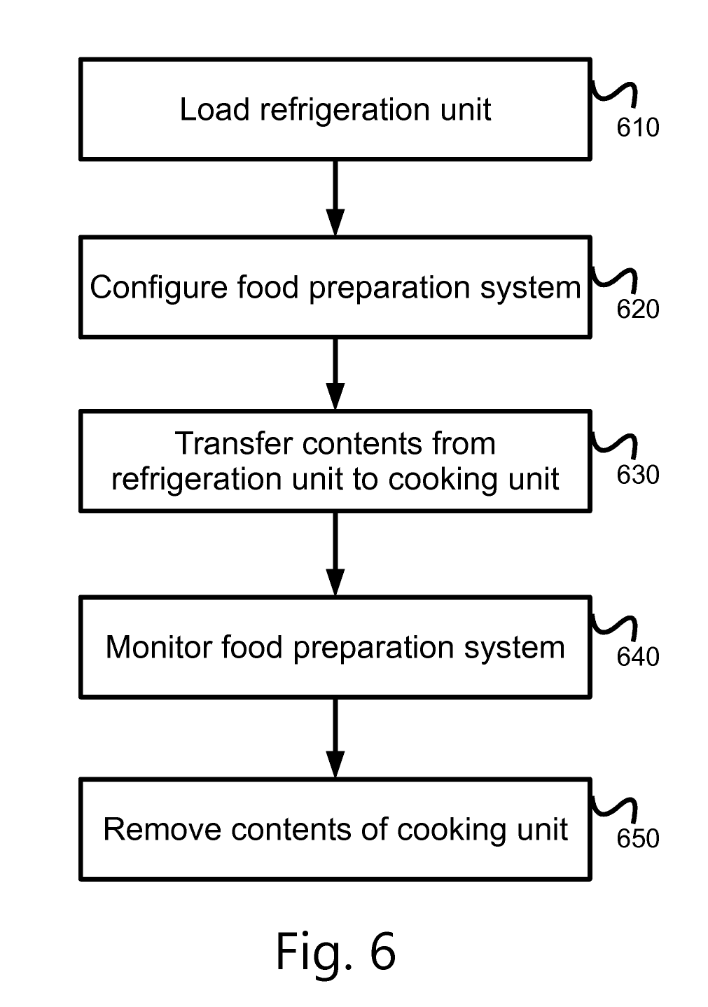

FIG. 6 depicts a method for configuring food preparation system 100 or 410 for use via, for example, communication device 420 and/or input components integrated with or in communication with food preparation system 100/410.

In one aspect, at step 610, a user can load ingredients and/or food items into refrigeration unit 110. Alternatively or additionally, the user may also load liquid ingredients into one or more reservoirs 310 of transportation unit 120.

The user may then configure aspects of food preparation system 100 at step 620. For example, the user may activate refrigeration unit 110, schedule a time for activation of refrigeration unit 110, set a temperature for refrigeration unit 110, schedule a temperature profile (i.e., configure temperature variations) for refrigeration unit 110, schedule the movement of items within refrigeration unit 110 to cooking unit 130, deactivate (i.e., turn off) refrigeration unit 110, schedule a time for deactivating refrigeration unit 110, schedule the displacement of contents of one or more reservoirs 310 (collectively or one or more reservoirs independent of another) to cooking unit 130, activation of cooking unit 130, schedule a time for activation of cooking unit 130, set a temperature for cooking unit 130, schedule a temperature profile for cooking unit 130, deactivate (i.e., turn off) cooking unit 130, and/or schedule a time for deactivating cooking unit 130. Of course, these are only examples of aspects of food preparation system 100 that a user may configure. Other possibilities exist and the user may configure any suitable aspect of food preparation system 100.

At step 630, in response to an input of the user and/or in accordance with a schedule set by the user, the contents of refrigeration unit 110 may be transported to cooking unit 130. At the same time or at a different time, and also in response to an input of the user or in accordance with a schedule set by the user, the contents of one or more reservoirs 310 may be transported to cooking unit 130. The contents of cooking unit 130 may then be heated and/or cooked in response to an input of the user or in accordance with a schedule set by the user.

At step 640, the user may monitor the state of food preparation system 100 either directly or remotely. In one embodiment, the user may receive information via network 430 regarding one or more aspects of food preparation system 100, including but not limited to, the current state (i.e., on/off) of refrigeration unit 110, transportation unit 120, and/or cooking unit 130, the current temperature or temperature rate of change associated with refrigeration unit 110 and/or cooking unit 130, the location of any food items (i.e., whether food is still located in refrigeration unit 110 or whether food has been transported to cooking unit 130), the contents of one or more reservoirs 310 and/or an indication of how full each reservoir may be, and/or a time elapsed or remaining for any one or more aspects of a refrigeration/cooking schedule. Of course, these are only examples of aspects of food preparation system 100 that a user may monitor. Other possibilities exist and the user may monitor any suitable aspect of food preparation system 100. For example, food preparation system 100 may further comprise a camera for monitoring the appearance of system 100 in real-time or on a recorded basis.

At step 650, the cooking unit 130 may complete cooking or heating the contents delivered from refrigeration unit 110 and/or reservoirs 310. In one embodiment, upon completion of a cooking schedule, cooking unit 130 may deactivate (i.e., turn off). In other embodiments, upon completion of a cooking schedule, cooking unit may maintain an internal temperature suitable for keeping any contents warm until a user removes them.

Additional features may also be incorporated into the described systems and methods to improve their functionality. For example, systems may include an alert system to notify a user when one or more aspects of food preparation system 100 fall outside predetermined thresholds and/or one or more components of system 100 are behaving unexpectedly. Database 440 may further comprise food preparation preferences or suggestions by other users, such that food preparation information is “crowd-sourced” and/or shared among members of a social network.

Other embodiments of the aforementioned systems and concepts will be apparent to those skilled in the art from consideration of the specification and practice of this disclosure. It is intended that the specification and examples be considered as illustrative only, with the true scope and spirit of the disclosure being indicated by the following claims.

What is claimed is:

1. A system for preparing food, the system comprising:
a refrigeration unit comprising an inner liner defining a refrigeration cavity;
a cooking unit comprising a lid substantially covering a cooking cavity; and
a transportation unit configured to transport a first content item from the refrigeration cavity to the cooking cavity.

2. The system of claim 1, further comprising a control unit for receiving information transmitted by a remote communication device, the control unit further configured to initiate movement of at least one component of the transportation unit based, at least in part, on the information transmitted by the remote communication device.

3. The system of claim 1, further comprising at least one reservoir containing a second content item, the reservoir in fluid communication with the at least one component of the transportation unit.

4. The system of claim 3, wherein the transportation unit is further configured to transport the second content item from the at least one reservoir to the cooking unit via one or more ports of the at least one component of the transportation unit.

5. The system of claim 1, wherein the at least one component of the transportation unit is configured to simultaneously displace the liner of the refrigeration unit and the lid of the cooking unit.

6. The system of claim 2, wherein the at least one component of the transportation unit is coupled to the liner of the refrigeration unit and the lid of the cooking unit is positioned in a path along which the at least one component translates.

7. The system of claim 6, wherein the control unit is further configured to set state information of the refrigeration unit and state information of the cooking unit.

8. A method for remote food preparation, the method comprising:
receiving information over a network from a remote communication device;
based, at least in part, on the received information:
setting a state of a refrigeration unit;
initiating transportation of a content item from the refrigeration unit to the cooking unit; and
setting a state of a cooking unit.

9. The method of claim 8, wherein setting the state of the refrigeration unit comprises activating the refrigeration unit.

10. The method of claim 8, wherein setting the state of the refrigeration unit comprises setting at least one of a refrigeration temperature, a refrigeration temperature variation schedule, and a refrigeration time period.

11. The method of claim 8, wherein setting the state of the cooking unit comprises activating the cooking unit.

12. The method of claim 8, wherein initiating transportation of the content item from the refrigeration unit to the cooking unit comprises:
coupling a transportation component to a liner of the refrigeration unit, the liner at least partially surrounding a food item;
moving the transportation component across a plane at least partially coincident with a lid of the cooking unit so as to displace the lid from the cooking unit;
positioning at least a portion of the liner of the refrigeration unit substantially above the cooking unit; and
releasing the food item from the liner into the cooking unit.

13. The method of claim 12, wherein the liner comprises a container having at least one opening at a lower surface.

14. The method of claim 12, wherein moving the transportation component across the plane comprises sliding the transportation component along a pair of opposing rails, each rail located one an opposite side of the cooking unit.

15. An apparatus for remotely preparing food, the apparatus comprising:
a control unit configured to receive information transmitted from a remote communication device;
a refrigeration unit comprising a transfer door coupled to an interior liner defining a refrigeration cavity;
a cooking unit comprising a lid substantially covering a cooking cavity; and
a transportation component configured to transport a content item from the refrigeration cavity to the cooking cavity based, at least in part, on the information transmitted from the remote communication device.

16. The apparatus of claim 15, further comprising a pair of rails along which the transportation component traverses.

17. The apparatus of claim 16, wherein the transportation component is coupled to the transfer door of the refrigeration unit and the lid of the cooking unit, such that traversal of the transportation component results in the concurrent movement of the transfer door and the lid.

18. The apparatus of claim 17, wherein the lid of the cooking unit is at least partially supported by the pair of rails such that the traversal of the transportation component results in the lid moving along the pair of rails.

19. The apparatus of claim 17, wherein the traversal of the transportation component results in at least partial removal of the lid from over the cooking cavity and the placement of at least a portion of the interior liner of the refrigeration unit over the cooking cavity.

20. The apparatus of claim 19, wherein the interior liner of the refrigeration unit defines an opening in a lower surface sufficient for the content item to drop from the interior liner to the cooking cavity.
